(19) United States
(12) Patent Application Publication
(10) Pub. No.: US 2015/0290727 A1
(43) Pub. Date: Oct. 15, 2015

(54) METHOD AND APPARATUS FOR CUTTING UNDERWATER STRUCTURES

(71) Applicant: Francesco Matteucci, Genova (IT)

(72) Inventor: Francesco Matteucci, Genova (IT)

(21) Appl. No.: 14/374,211

(22) PCT Filed: Jan. 31, 2012
(86) PCT No.: PCT/IT2012/000028

§ 371 Date: Jul. 23, 2014

(51) Int. Cl. B23D 53/00

(52) U.S. Cl. CPC B23D 53/008; B23D 53/001

(57) ABSTRACT

A method for cutting an underwater structure below the level of the seabed on which it is installed is described. The method has the following steps: positioning cutting means and penetrating means associated with the cutting means in close proximity to the underwater structure to be cut, at the intersection region between the structure and the seabed; causing both the penetrating means and the cutting means associated therewith to penetrate into the seabed in a substantially longitudinal direction to a portion of the structure which is embedded in the seabed; and actuating and driving the cutting means and the penetrating means in a substantially perpendicular direction to the embedded portion so as to cut the structure below the level of the seabed. An apparatus for carrying out the method is also described.

The present invention relates to a method and apparatus for cutting underwater structures.

Currently, submerged structures are cut employing different methods and using apparatuses of different nature with the purpose of removing and/or replacing the same.

Some of the known cutting devices make use of fixed blades, such as that described in document U.S. Pat. No. 3,056,267, while others are provided with several rotary blades coordinated in their action, such as that described in document U.S. Pat. No. 4,180,047. However, both apparatuses have the drawback of operating only on the emerging, free end of the submerged structure.

In document EP-B-0540834 there are disclosed a method and device for cutting underwater structures which make use of a diamond cable as a cutting means; the device allows the underwater structure to be cut at any level between the seabed and the surface.

Nowadays, the in-force provisions governing the field and applied worldwide, which are extremely more strict as for what concerns the environmental protection, require that submerged structures are cut below the level of the seabed, without leaving potentially dangerous stumps of the cut structure emerging from the seabed. Under these conditions and employing the presently available means, it is required to remove a considerable amount of seabed around the base of the structure to be cut. This additional operation is cost- and time-consuming, and it often damages the environment which should be safeguarded instead.

From document GB-A-409754, an apparatus is known to demolish an underwater structure. Said apparatus comprises a boring tool, namely an auger, which is guided with a guiding tube; the boring tool creates a series of holes diagonally into the structure, even below the level of the seabed, in order to weaken the structure as well as to allow the removal thereof. Alternatively, the hole created by the boring tool can be used for positioning a charge of explosive. However, such a method does not appear neither safe nor easy to be used.

Document EP-B-1373645 (hereinafter referred to as “document '645”) discloses a method and apparatus for cutting an underwater structure below the level of the seabed on which it is installed. The method of document '645 includes the sequential steps of determining the ideal plane of cutting having taken in account characteristic features of the structure such as its morphology and positioning on the seabed, the shape and consistency of the seabed, and the depth below the level of the seabed at which the cutting has to be performed; positioning and anchoring cutting means in the proximity of the cutting area; boring at least one hole through the seabed in the proximity of the structure, at least up to the depth at which the cutting has to be performed, along a direction parallel to the cutting direction and lying on the cutting plane; introducing said cutting means into said hole, and cutting the structure, said cutting being performed outside of said hole. In document '645, the apparatus adapted for carrying out the method of the same patent includes boring means to bore the hole; cutting means comprising a cutting frame and a movable cutting unit which, in use, at least partially radially projects from said hole, means for positioning said boring means and said cutting means; and anchoring means.

However, while the method and apparatus as disclosed in document '645 achieve the intended goal of performing the cutting below the seabed, they still have certain drawbacks. Indeed, since the practice has shown that cutting is performed substantially obliquely to the structure to be cut, cutting is more difficult to be initiated and it takes more time than if it were possible to cut substantially perpendicularly to the structure. Finally, the on-field practice has shown that the movable cutting unit often suffers from clogging problems with the debris of the seabed which limit the performance thereof.

Therefore, an object of the present invention is to provide a method for cutting an underwater structure which allows to obtain said cutting below the level of the seabed with a minimum expenditure of means and of energies, with the least impact as possible on the surrounding marine environment, and with an increased efficiency and easiness when compared to the methods of the prior art.

A further object of the present invention is to provide an apparatus adapted for carrying out the above-described cutting method.

Therefore, an object of the present invention is a method for cutting an underwater structure, typically a support pier of an offshore production platform, below the level of the seabed on which it is installed, comprising the following steps: a step of positioning cutting means and penetrating means associated with said cutting means in close proximity to the underwater structure to be cut, at the intersection region between said structure and the seabed; a step of causing both said penetrating means and said cutting means associated therewith to penetrate into said seabed in a substantially longitudinal direction to a portion of said structure which is embedded in the seabed; and a cutting step which includes actuating and driving said cutting means and said penetrating means in a substantially perpendicular direction to said embedded portion so as to cut said structure below the level of the seabed.

In a preferred embodiment of the method of the present invention, said penetrating step includes causing said penetrating means and said cutting means to penetrate into the seabed in a substantially longitudinal direction to said embedded portion of said structure and, simultaneously or sequentially, moving said penetrating means and said cutting means towards said embedded portion so as to partially wind said cutting means around said embedded portion, said cutting means being of a flexible type.

In a further preferred embodiment of the method of the present invention, said cutting step includes exerting a stretching action on said flexible cutting means while they are actuated and driven, along with the penetrating means associated therewith, in a substantially perpendicular direction to said embedded portion so to obtain a substantially perpendicular transversal cut of said structure below the level of the seabed.

In another preferred embodiment of the method of the present invention, said cutting step includes applying a swinging movement to both said penetrating means and said cutting means while they are actuated and driven in a substantially perpendicular direction to said embedded portion so to obtain a substantially perpendicular transversal cut of said structure below the level of the seabed.

In yet another preferred embodiment of the method of the present invention, said penetrating step includes causing said penetrating means and said cutting means to penetrate into the seabed in a longitudinal direction to said embedded portion of said structure and, simultaneously or sequentially, moving said penetrating means and said cutting means towards said embedded portion so as to partially wind said cutting means around said embedded portion, said cutting means being of a flexible type, and wherein said cutting step includes first exerting a stretching action on said flexible cutting means and then applying a swinging movement to both said penetrating means and said cutting means while they are actuated and driven in a substantially perpendicular direction to said embedded portion so to obtain a substantially perpendicular transversal cut of said structure below the level of the seabed.

In a further variant embodiment, while the cut is being performed, the cutting means can be moved along the effective direction of penetration and in the way opposite to the way of penetration so as to cut the structure with a non-coplanar cut geometry in order to prevent a potential slipping of the portion of the structure being cut.

Another object of the present invention is an apparatus adapted for carrying out the method of the present invention, said apparatus being characterized as comprising a penetrating/cutting frame, an anchoring frame, and a swinging frame which connects the penetrating/cutting frame to the anchoring frame.

Preferably, the penetrating/cutting frame of the apparatus according to the present invention comprises a diamond-edged cable driven along a closed circuit by a series of pulleys between two parallel, mutually spaced tubular columns which, at one end, are transversally connected by a rigid back plate in such a manner that the penetrating/cutting frame has a fork shape, and which, at the free end, carry respective perforating devices each preferably comprising a cutting head and a respective motor drive unit.

More preferably, said series of pulleys, which are accommodated within the columns, comprises an aligned pair of swivel pulleys which are positioned in the proximity of the free ends of the respective columns so as to subtend a cutting portion of the diamond-edged cable, and a pulley which is provided with a motor drive unit for moving the diamond-edged cable along the closed circuit at a certain speed.

Even more preferably, the apparatus according to the present invention comprises a compensating device for changing the geometry of said cutting portion of the diamond-edged cable from a rectilinear configuration to a curved or angled configuration, and vice versa.

In a preferred embodiment of the apparatus according to the present invention, the apparatus further comprises auxiliary ejecting nozzles to assist the swinging frame in its swinging movement to drive the active portion of the penetrating/cutting frame towards the underwater structure to be cut, said auxiliary ejecting nozzles preferably comprising ejecting nozzles arranged on the penetrating/cutting frame and supplied with a pressurized fluid from supply lines.

### BRIEF DESCRIPTION OF THE DRAWINGS

FIG. 1 is a side elevation view of the apparatus according to a preferred embodiment of the present invention;

FIG. 2 is a front elevation view of the penetrating/cutting frame of the apparatus shown in FIG. 1;

FIG. 3 is a front elevation sectional view of the penetrating/cutting frame shown in FIG. 2 with the cutting means in a first configuration;

FIG. 4 shows a cross-section of the penetrating/cutting frame with the cutting means in the first configuration as shown in FIG. 3;

FIG. 5 is a front elevation sectional view of the penetrating/cutting frame shown in FIG. 2 with the cutting means in a second configuration;

FIG. 6 shows a cross-section of the penetrating/cutting frame with the cutting means in the second configuration as shown in FIG. 5;

FIG. 7 is a front elevation view of the anchoring frame of the apparatus shown in FIG. 1;

FIG. 8 is a side elevation view of the anchoring frame shown in FIG. 7;

FIGS. 9 and 10 show top plan views of the anchoring frame shown in FIGS. 7 and 8 in two different configurations;

FIG. 11 is a side elevation view of the swinging frame having mounted thereto the penetrating/cutting frame;

FIGS. 12 and 13 are front elevation views of the two half-frames comprising the swinging frame shown in FIG. 11;

FIGS. 14 and 15 are side elevation views of the swinging frame having mounted thereto the penetrating/cutting frame in two further different configurations;

FIGS. 16 and 17 are side elevation views showing another preferred embodiment of the swinging frame having mounted thereto the penetrating/cutting frame;

FIG. 18 is a sectional plan view of the apparatus shown in FIG. 1;

FIGS. 19-22 show the major embodiment steps of the embodiment method for the apparatus according to the present invention; and

FIGS. 23, 24 and 25 are respectively a side elevation view, a front elevation view and a cross-section of the penetrating/cutting frame having mounted thereto the auxiliary ejecting means according to a preferred embodiment of the apparatus of the present invention.

### DESCRIPTION OF THE PREFERRED EMBODIMENTS

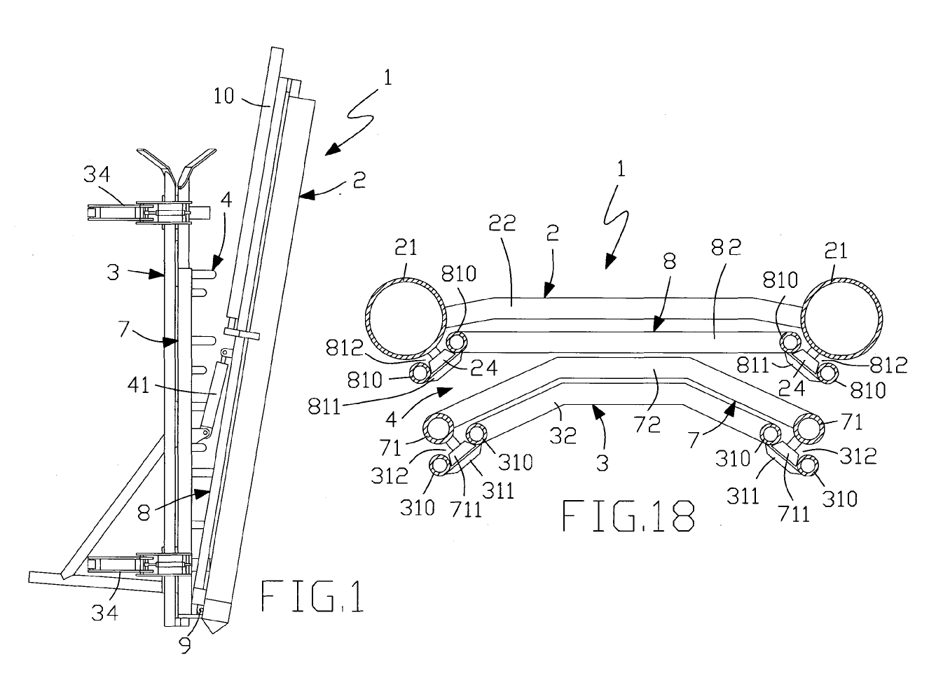

Referring now to the present invention in greater detail, FIG. 1 shows an overall side view of a cutting apparatus 1 according to a preferred embodiment of the present invention, comprising a penetrating/cutting frame 2, an anchoring frame 3, and a swinging frame 4 which connects the penetrating/cutting frame 2 to the anchoring frame 3. Particularly, also referring to FIG. 2 and assuming that like reference numerals will denote like elements throughout the different figures, the penetrating/cutting frame 2 includes two parallel, mutually spaced columns 21, 21 which, at one end, are transversally connected by a rigid back plate 22 in such a manner that the penetrating/cutting frame 2 has a fork shape. At the free ends, the columns 21, 21 carry respective perforating devices 23, 23. At the back plate 22, each column 21 carries a series of sliding rollers 24.

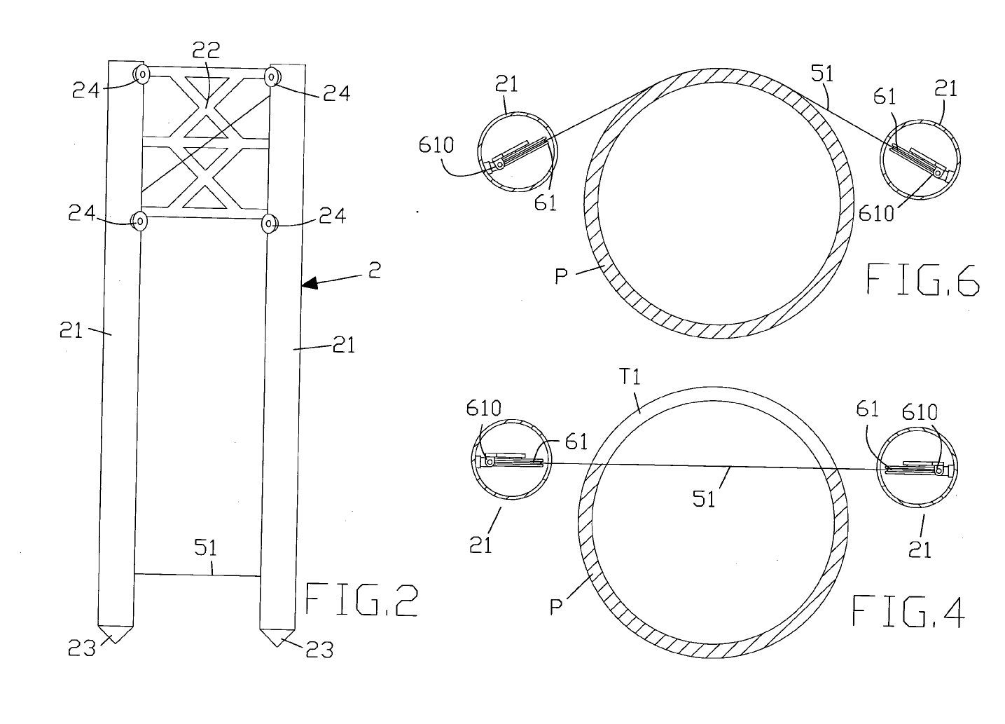

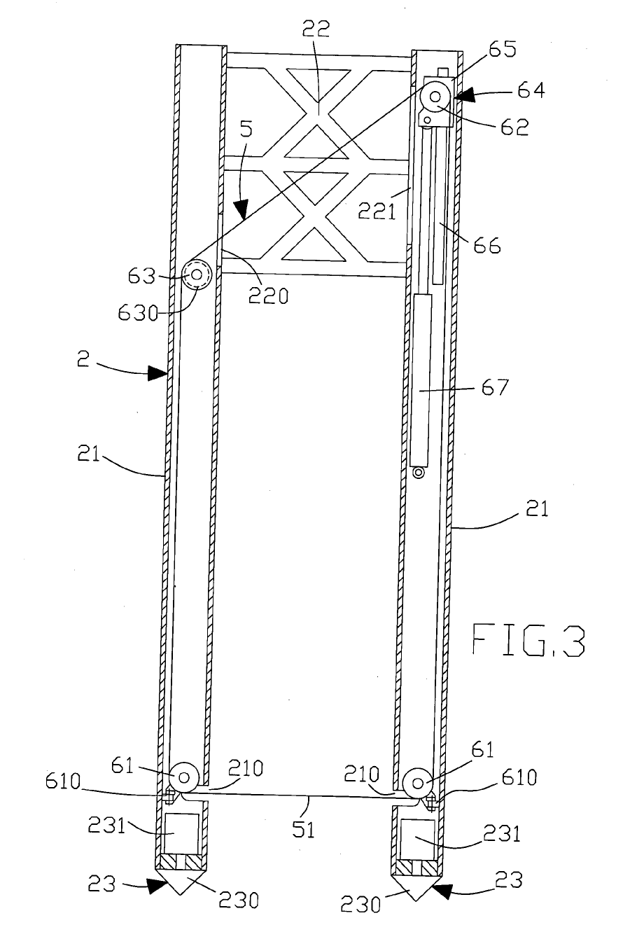

Also referring to FIGS. 3-6, the columns 21, 21 are constituted of tubular uprights accommodating pulleys 61, 61, 62 and 63 adapted for driving cutting means, in the form of a diamond-edged cable 5, along a closed circuit partially running through the columns 21, 21. Pulleys 61, 61 are positioned in reciprocal alignment with each other in the proximity of the free ends of the respective columns 21, 21, and they subtend an active cutting portion 51 of the diamond-edged cable 5.

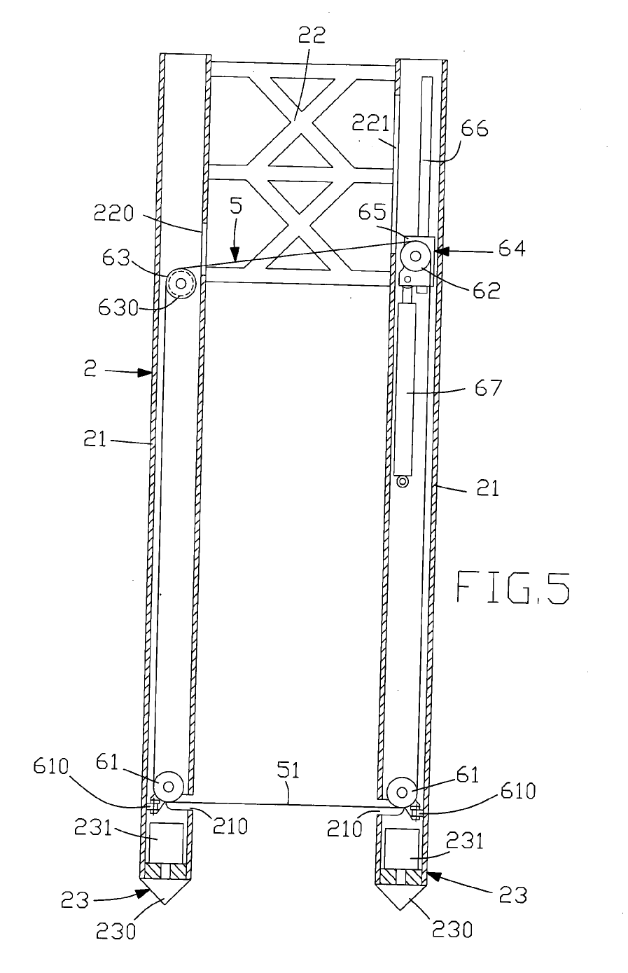

For reasons that will appear clear hereinafter, said cutting portion 51 can take on two alternate configurations, i.e. a rectilinear configuration (FIGS. 3 and 4) and a curved configuration (FIGS. 5 and 6) and, to this end, both the pulleys 61, 61 are swivel-mounted on pins 610, 610. One of the two columns 21, 21 has accommodated therein, in opposition to the pulley 61, a compensating device 64 which allows the configuration of said cutting portion 51 of the diamond-edged cable 5 to be changed from said rectilinear configuration to said curved configuration, and vice versa. Said compensating device 64 includes the driven pulley 62 mounted to a slide 65 driven along a rectilinear guide 66 arranged inside the column 21 which also accommodates a linear actuator 67 adapted for translating the assembly comprising the pulley 62 and the slide 65 along the rectilinear guide 66. Instead, the pulley 63, which is accommodated inside the other column 21 and provided with a motor drive unit 630, is adapted for slidably driving the diamond-edged cable 5 along the closed circuit at the desired work speed.

In order to allow the diamond-edged cable 5 to pass from one column 21 to the other, there are provided passage windows 210, 210 at the free ends of the columns and passage windows 220, 221 at the connected ends thereof. Obviously, the window 221 has such a length to allow the cable to extend longitudinally while the configuration of its cutting portion 51 is changed from the rectilinear configuration to the curved configuration, and vice versa. Each of the perforating devices 23 includes a cutting head 230 and a relevant motor drive unit 231.

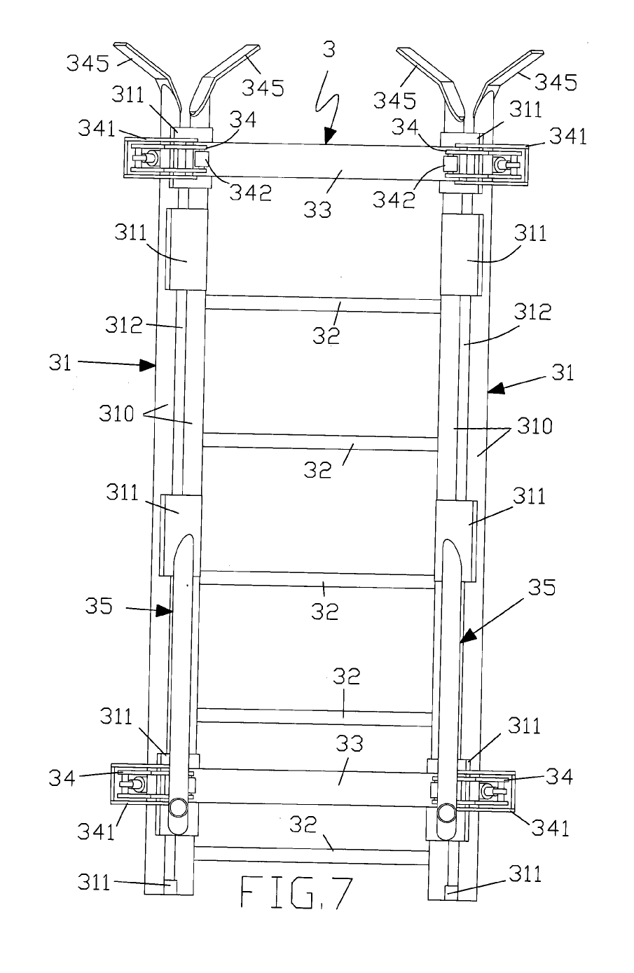

Referring now to FIGS. 7-10, said anchoring frame 3 is substantially constituted of two mutually parallel and spaced spars 31, 31 which are transversally connected by several transversal members 32 and 33. Each spar 31 is constituted of two parallel neighbouring bars 310 which are connected by several attachment plates 311 to define a guiding groove 312 extending substantially over the entire length of the bars. The anchoring frame 3 has mounted thereto securing means which are positioned at the transversal members 33 and connected thereto, said securing means comprising a pair of jaws 34, 34 each of which is hinged, at 340, to a support 341 attached to the transversal member 33. Each jaw 34 carries, at one end, a gripping roller 342 and, at the other end, an angled fin 343 which is hingedly engaged by a linear actuator 344 to actuate the jaw. Preferably, each pair of bars 310 has, at one end, two opposite angled guiding plates 345 outwardly diverging from each other. In the proximity of the opposite end of each pair of bars 310, the frame 3 carries an extension 35 substantially triangular in shape and faced in the same direction as the jaws, substantially perpendicularly to the plane of the frame 3.

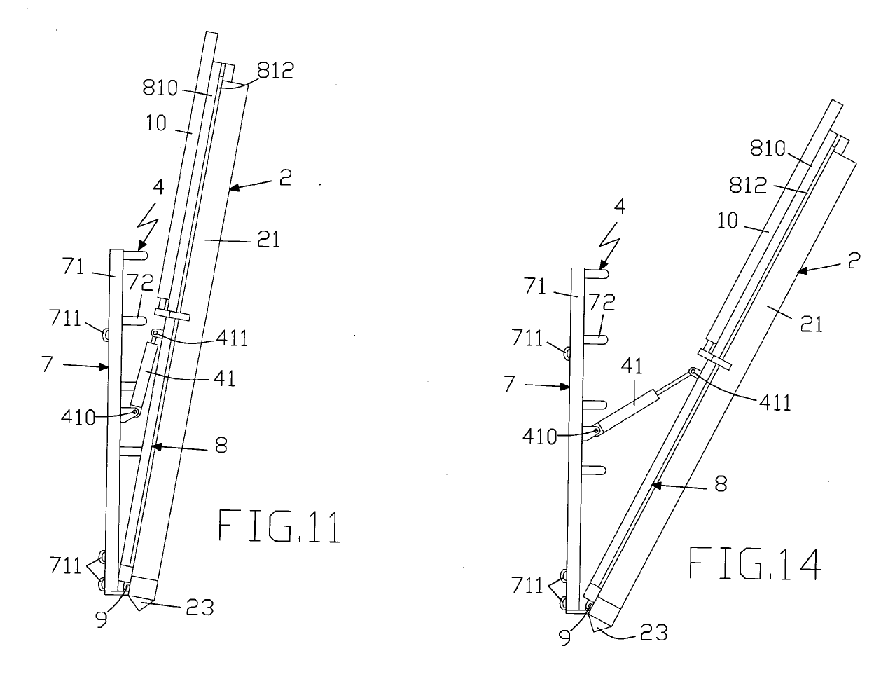

Referring now to FIGS. 11-15, said swinging frame 4 includes two half-frames 7 and 8 which are hinged to each other at one end in 9. Particularly, the half-frame 7 is constituted of two mutually parallel and spaced side-members 71 which are transversally connected by a series of ribs 72. Furthermore, each of the two side-members 71 is provided with a series of rollers 711 arranged along its length. Similarly, the half-frame 8 is constituted of two mutually parallel and spaced side-members 81 which are transversally connected by a series of ribs 82. Each spar 81 is constituted of two parallel neighbouring bars 810 which are connected by at least one pair of attachment plates 811 to define a guiding groove 812 extending substantially over the entire length of the bars. The angular opening of two half-frames 7 and 8 is adjusted by a linear actuator 41 which is hingedly mounted between the two half-frames 7 and 8 in 410 and 411, respectively.

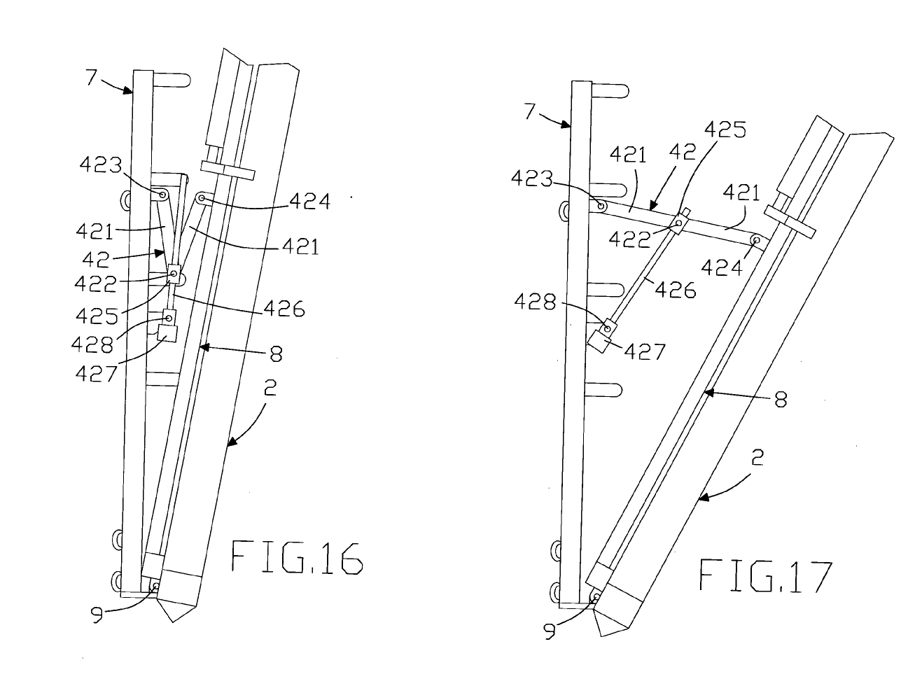

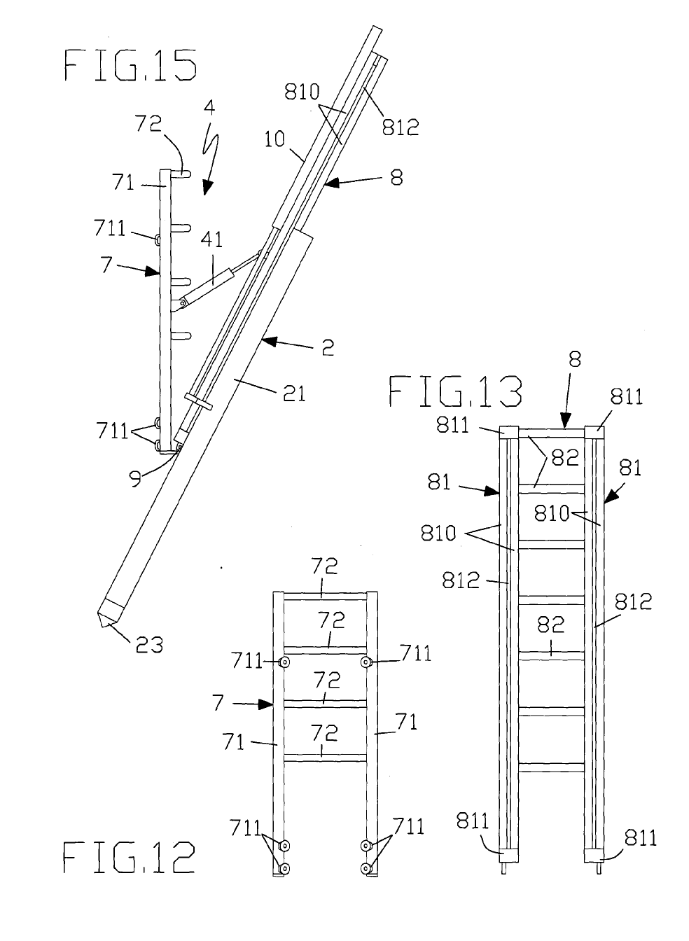

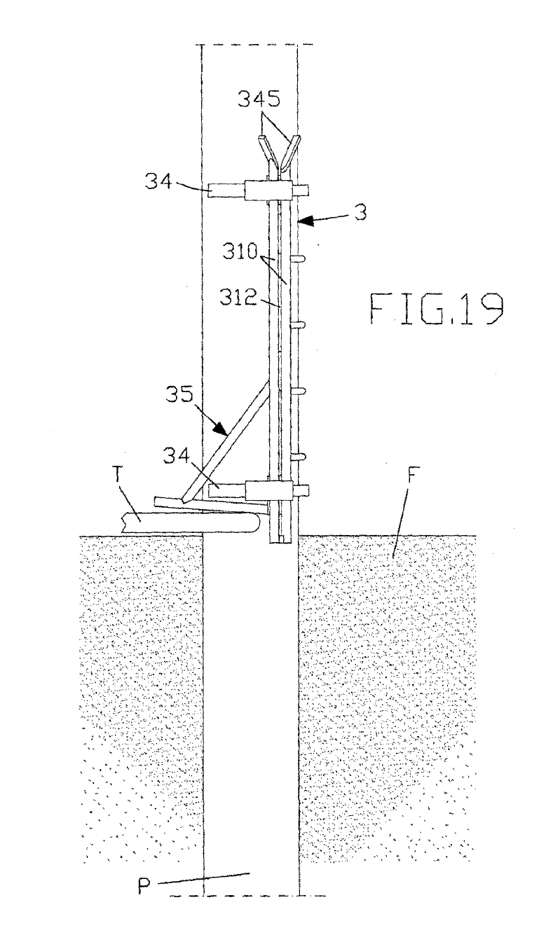

Alternatively, as it can be seen from FIGS. 16 and 17, the linear actuator 41 can be replaced with an opening-adjusting device 42. Such a device is constituted of two levers 421, 421 which, at one end, are hinged to each other in 422, and which, at the other end thereof, are pivoted to the two half-frames 7 and 8 in 423 and 424, respectively. The pivot point 422 of the two levers 421 has swivel-mounted thereon an axial female threaded sleeve 425 with a threaded shaft 426 engaged therewith which is rotatably driven by a motor drive unit 427 articulated to the half-frame 7 in 428. As it can be deduced comparing FIGS. 16 and 17, the rotation of the threaded shaft 426 results in an axial movement of the sleeve 425 which causes the two half frames 7 and 8 to move towards each other and away from each other.

Referring now to FIGS. 11 and 18, there is shown the connection relationship between the penetrating/cutting frame 2 and the half-frame 8 of the swinging frame 4. As it can be seen, the rollers 24 of each column 21 slidably engage the respective guiding groove 812 of the half-frame 8 in such a manner that the penetrating/cutting frame 2 can slide with respect to the half-frame 8, as it will be clear from FIG. 15. This sliding movement is performed by a linear actuator 10 which is mounted between the penetrating/cutting frame 2 and the half-frame 8 of the swinging frame 4.

Similarly, referring to FIGS. 7 and 18, there is shown the connection relationship between the half-frame 7 of the swinging frame 4 and the anchoring frame 3. In this case, as it can be observed, the rollers 711 of each of the side-members 71 of the half-frame 7 engage the respective guiding groove 312 of the anchoring frame 3 in order to secure the half-frame 7, and therefore the swinging frame 4, to the anchoring frame 3. This engagement operation is assisted by the two guiding plates 345 of the anchoring frame 3.

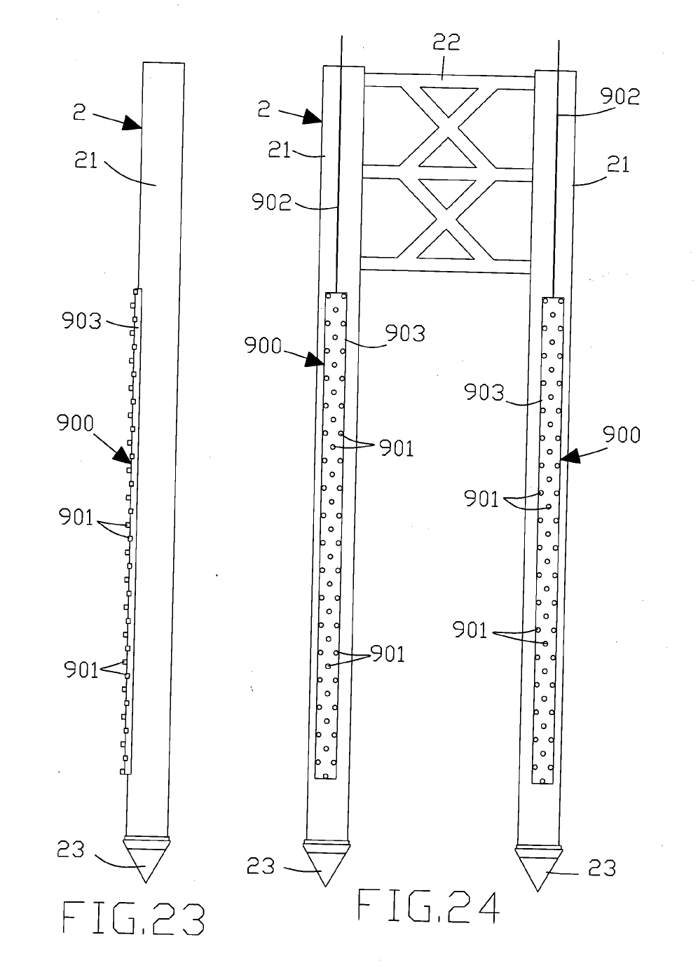

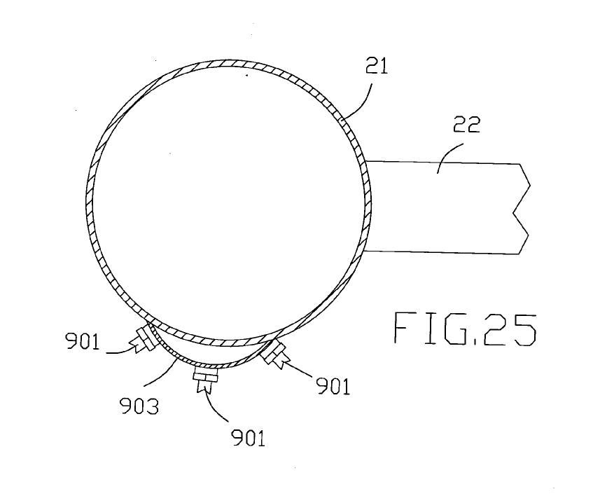

Furthermore, FIGS. 23, 24 and 25 show that the penetrating/cutting frame 2 of the cutting apparatus according to the present invention can be provided with auxiliary ejecting means 900 to assist the swinging chassis 4 in its curvilinear movement which drives the active portion of the penetrating/cutting frame 2 in the direction of the underwater structure to be cut. In this embodiment, such auxiliary ejecting means 900 are constituted of arrays of ejecting nozzles 901 arranged on the tubular columns 21, 21 and supplied with a pressurized fluid, typically pressurized water, from supply lines 902 which convey it towards the ejecting nozzles 901 through collecting conducts 903 mounted along the tubular columns 21, 21 and operatively connected to the arrays of ejecting nozzles 901. These ejecting nozzles 901 are to provide both a feedback hydrodynamic thrust force and a disaggregation action of the soil of the seabed while it is perforated by the perforating devices 23, 23. In the illustrated embodiment, the ejecting nozzles are arranged on the faces of the tubular columns 21, 21 which are directed towards the anchoring frame.

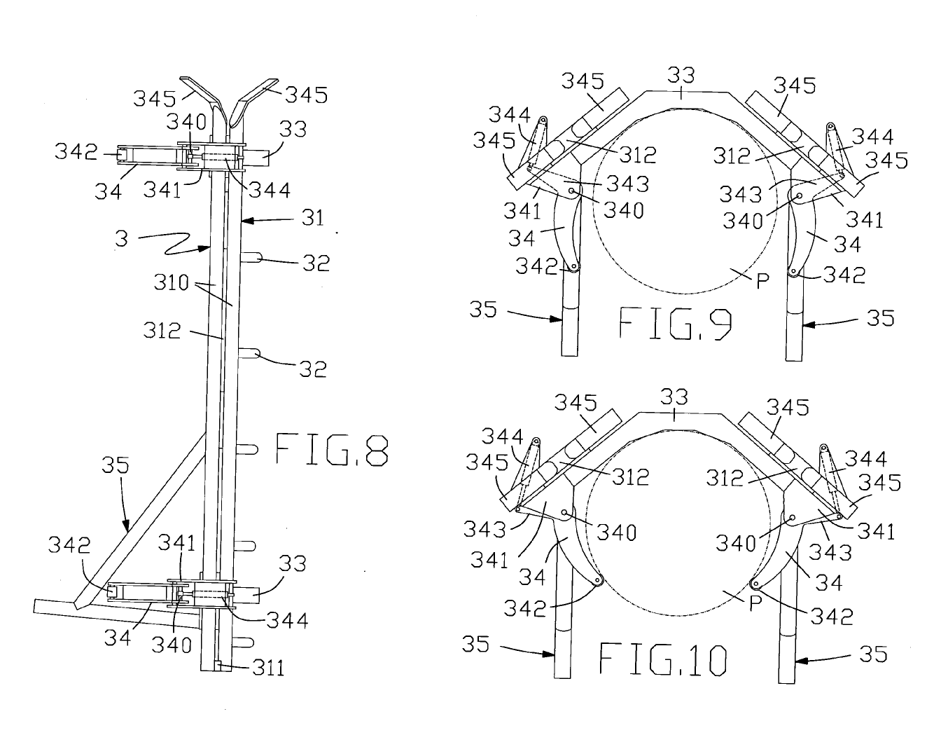

The application and the operation of the preferred embodiment of the cutting apparatus according to the present invention will be described hereinbelow. As already stated above, the cutting apparatus 1 is used to cut an underwater structure, typically a support pier P of an offshore production platform, below the level of a seabed F, in order to avoid that a potentially dangerous stump of the pier can emerge. In a preparative step and specifically referring to FIG. 19, the anchoring frame 3 is lowered from a support boat into water up to the base of the pier P and, with the help of divers or with the use of remotely controlled submarine vehicles, it is abutted against the pier and secured thereto by actuating the jaws 34, 34 (see also FIGS. 9 and 10). The operation of abutting the anchoring frame 3 against the pier P is facilitated by the presence of the fork, constituted of the extensions 35 of said frame, which can abut against possible transversal members T at the base of the pier P in order to confer an enhanced stability to the connection.

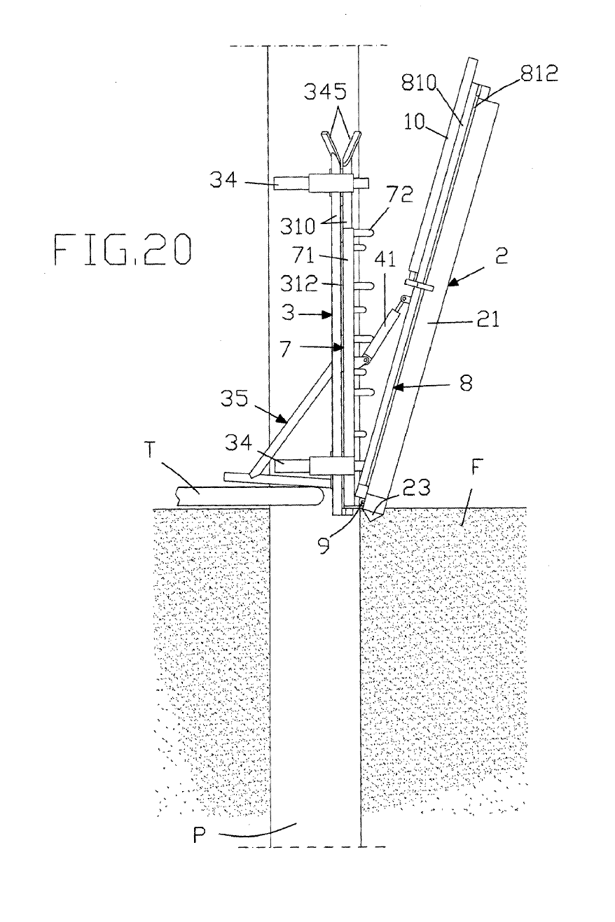

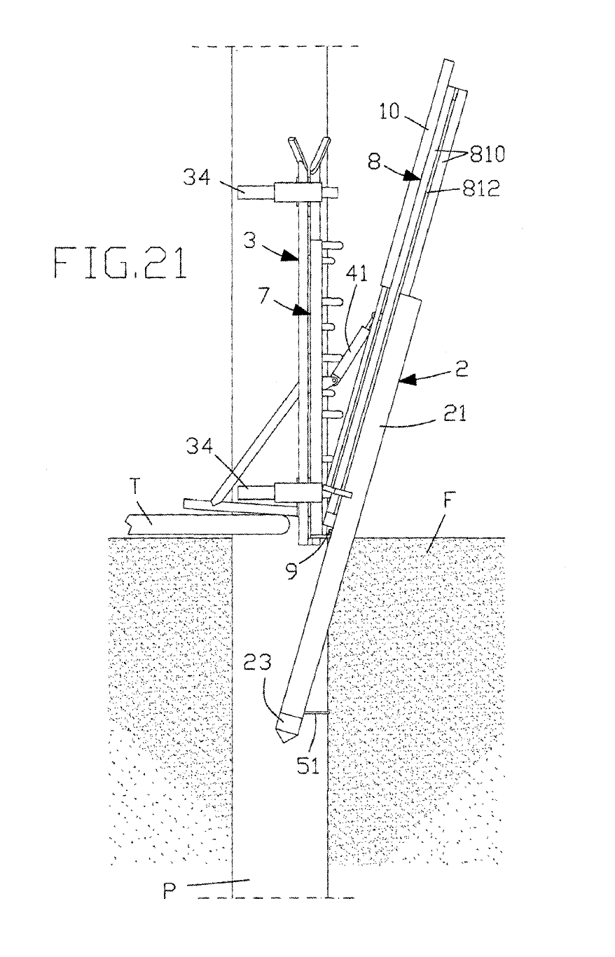

At this point, turning to FIG. 20, the assembly comprising the penetrating/cutting frame 2 and the swinging frame 4 is lowered into water, the assembly operation being performed either in factory or extemporaneously on the support boat itself. When this assembly is in the proximity of the anchoring frame 3 and with the help of the guiding plates 345, the rollers 711 of the half-frame 7 of the swinging frame 4 are fitted into the respective guiding grooves 312 of the anchoring frame 3, and they are moved until both the frames are engaged with each other over their whole length. The initial angle between the two half-frames 7 and 8 of the swinging chassis 4, and therefore between the penetrating/cutting frame 2 and the pier P, is a function of both the diameter of the pier and the desired type of cut.

When the three frames of the cutting apparatus 1 according to this preferred embodiment of the present invention are positioned appropriately, the perforating devices 23 at the ends of the columns 21 of the penetrating/cutting frame 2 are activated, and the entire penetrating/cutting frame 2 is lowered into the seabed by switching on its linear actuator 10. During this lowering step, the two columns 21, due to their initial angle of inclination, partially fork the pier P, thus causing the cutting portion 51 to partially wind around the pier in a perpendicular direction to the same, and to take on the curved configuration as already previously described and illustrated in FIG. 6. During this step of lowering into the seabed F, the diamond-edged cable 5 is driven at a low speed, thus exerting a moderate shear and therefore facilitating its positioning at the desired level without exposing it to the risk of getting clogged with seabed debris. At this time, in order to compensate for the curved condition of the cutting portion 51, the configuration of the circuit of the diamond-edged cable 5 is as illustrated in FIG. 5, with the compensating device 64 in a lowered position.

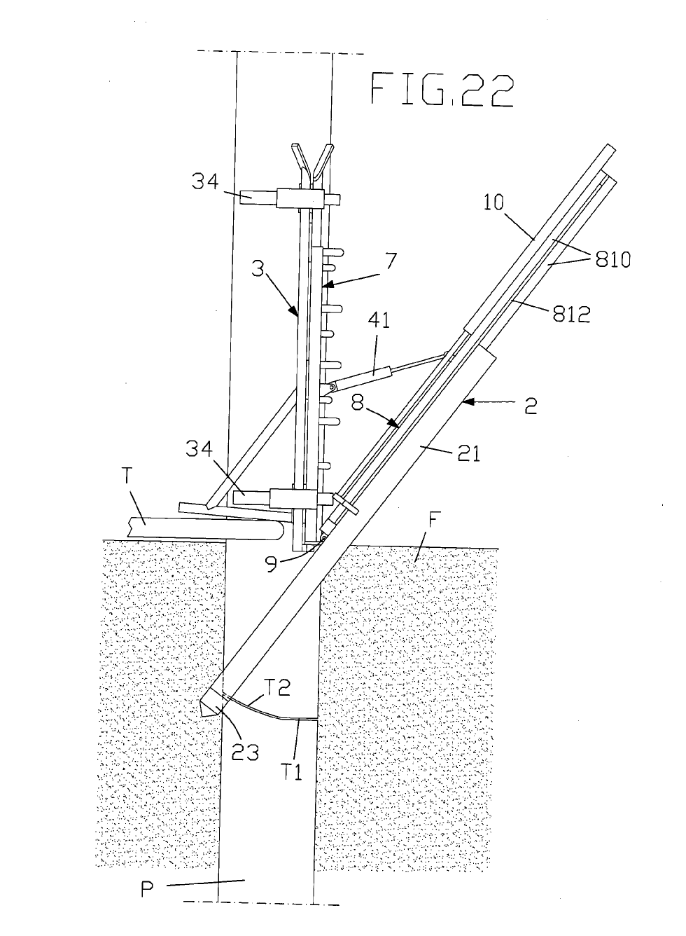

At this point, the diamond-edged cable 5 is activated at the desired work speed and, simultaneously, the compensating device 64 is lifted (FIG. 3) to cause the cutting portion 51 to take on the rectilinear configuration as shown in FIG. 4. This combined action allows to obtain a partial perpendicular cut T1 of the pier P. Subsequently, the penetrating/cutting frame 2 is further tilted by extending the linear actuator 41, until the cutting portion 51 is driven outside of the pier in order to complete the cutting of the pier with a curved cut T2. It has to be noted that, as best seen in FIGS. 20, 21 and 22, a major portion of the columns 21 of the penetrating/cutting frame 2 remains outside of the seabed and in the free water, so that the return length of the diamond-edged cable 5 can be cleared of debris possibly gathered during its cutting action into the seabed.

As it can be inferred from the above description, the cutting apparatus according to the present invention can perform a substantially perpendicular cut of the underwater structure below the level of the seabed without removing a considerable amount of soil at the base of the structure, and without clogging the cutting means with debris which could compromise its action. Furthermore, if it is required to cut more structures in the same area, for example more piers of an offshore production platform, the modular nature of the present apparatus allows, for example, to install an anchoring chassis for every pier to be cut, and to re-use the same penetrating/cutting frame—swinging frame assembly by mounting and removing it to/from the respective anchoring frame every time. Alternatively, the operation of assembling the three frames can be performed before the whole apparatus is lowered into water, either in factory or extemporaneously on the support boat.

1. A method for cutting an underwater structure below the level of the seabed on which it is installed, comprising the following steps:
positioning cutting means and penetrating means associated with said cutting means in close proximity to the underwater structure to be cut, at the intersection region between said structure and the seabed;
causing both said penetrating means and said cutting means associated therewith to penetrate into said seabed in a substantially longitudinal direction to a portion of said structure which is embedded in the seabed; and
actuating and driving said cutting means and said penetrating means in a substantially perpendicular direction to said embedded portion so as to cut said structure below the level of the seabed.

2. The method for cutting an underwater structure according to claim 1, wherein:
said penetrating step includes:
causing said penetrating means and said cutting means to penetrate into the seabed in a longitudinal direction to said embedded portion of said structure, and
moving, simultaneously or sequentially, said penetrating means and said cutting means towards said embedded portion so as to partially wind said cutting means around said embedded portion, and
said cutting means is being of a flexible.

3. The method for cutting an underwater structure according to claim 1, wherein said cutting step includes exerting a stretching action on said flexible cutting means while said flexible cutting means are actuated and driven, along with the penetrating means associated therewith, in a substantially perpendicular direction to said embedded portion so to obtain a substantially perpendicular transversal cut of said structure below the level of the seabed.

4. The method for cutting an underwater structure according to claim 1, wherein said cutting step includes applying a swinging movement to both said penetrating means and said cutting means while they are actuated and driven in a substantially perpendicular direction to said embedded portion so to obtain a substantially perpendicular transversal cut of said structure below the level of the seabed.

5. The method for cutting an underwater structure according to claim 1, wherein
said penetrating step includes:
causing said penetrating means and said cutting means to penetrate into the seabed in a longitudinal direction to said embedded portion of said structure, and
moving, simultaneously or sequentially, said penetrating means and said cutting means towards said embedded portion so as to partially wind said cutting means around said embedded portion, said cutting means being of a flexible type, and
said cutting step includes first exerting a stretching action on said flexible cutting means and then applying a swinging movement to both said penetrating means and said cutting means while both said penetrating means and cutting means are actuated and driven in a substantially perpendicular direction to said embedded portion so to obtain a substantially perpendicular transversal cut of said structure below the level of the seabed.

6. A cutting apparatus for cutting an underwater structure below the level of the seabed on which it is installed using the method according to claim 1, wherein the apparatus includes:
a penetrating/cutting frame,
an anchoring frame, and
a swinging frame which connects the penetrating/cutting frame to the anchoring frame.

7. The cutting apparatus for cutting an underwater structure according to claim 6, wherein the penetrating/cutting frame includes:
cutting means extending between two parallel, mutually spaced tubular columns which, at one end, are transversally connected by a rigid back plate in such a manner that the penetrating/cutting frame has a fork shape, and which, at a free end, carry respective perforating devices.

8. The cutting apparatus for cutting an underwater structure according to claim 7, wherein said cutting means include:
a diamond-edged cable driven along a closed circuit by pulleys accommodated within the columns,
an aligned pair of said pulleys being swivel pulleys and being positioned in the proximity of the free ends of the respective columns so as to subtend a cutting portion of the diamond-edged cable, and
a pulley being provided with a motor drive unit for slidably driving the diamond-edged cable along said closed circuit.

9. The cutting apparatus for cutting an underwater structure according to claim 8, wherein said cutting means include a compensating device which allows the geometry of said cutting portion of the diamond-edged cable to be changed from a rectilinear configuration to a curved or angled configuration, and vice versa.

10. The cutting apparatus for cutting an underwater structure according to claim 9, wherein said compensating device is accommodated within one of the two tubular columns and includes the driven pulley which is mounted on a slide driven along a rectilinear guide by a linear actuator.

11. The cutting apparatus for cutting an underwater structure according to claim 6, wherein each of said perforating devices includes a cutting head and a respective motor drive unit.

12. The cutting apparatus for cutting an underwater structure according to claim 6, wherein said anchoring frame includes two mutually parallel and spaced spars which are transversally connected by several transversal members, each of the two spars comprising two parallel neighbouring bars which are connected by several attachment plates to define a guiding groove extending substantially over the entire length of the bars, the transversal members of the anchoring frame having mounted thereto securing means comprising a pair of jaws, each of which is actuated by a respective actuator and hinged, at a pivot point, to a support attached to the transversal member.

13. The cutting apparatus for cutting an underwater structure according to claim 6, wherein said swinging frame includes a first half-frame and a second half-frame which are hinged to each other at one end at a pivot point, said swinging frame further comprising actuating means to move both the half-frames towards each other and away from each other.

14. The cutting apparatus for cutting an underwater structure according to claim 13, wherein said actuating means comprise a linear actuator hingedly mounted between the two half-frames.

15. The cutting apparatus for cutting an underwater structure according to claim 13, wherein said actuating means comprise two levers which, at one end, are hinged to each other at a pivot point and which, at the other end thereof, are pivoted to the two half-frames at respective pivot points, the pivot point having swivel-mounted thereon an axial female threaded sleeve with a threaded shaft engaged therewith which is rotatably driven by a motor drive unit articulated to the first half-frame at a pivot point.

16. The cutting apparatus for cutting an underwater structure according to claim 13, wherein each of the two half-frames of said swinging frame includes, respectively, pairs of mutually parallel and spaced side-members which are transversally connected by a respective series of ribs, each of the two side-members of the second half-frame being formed from two parallel neighbouring bars which are connected by at least one pair of attachment plates to define a guiding groove extending substantially over the entire length of the bars.

17. The cutting apparatus for cutting an underwater structure according to claim 6, wherein the connection between the penetrating/cutting frame and the swinging frame is established by slidable coupling means.

18. The cutting apparatus for cutting an underwater structure according to claim 16, wherein said slidable coupling means include, on the side of the penetrating/cutting frame, two sets of sliding rollers which engage the guiding grooves of the second half-frame of the swinging frame, a linear actuator being mounted between the penetrating/cutting frame and the second half-frame.

19. The cutting apparatus for cutting an underwater structure according to claim 6, wherein the connection between the anchoring frame and the swinging frame is established by slidable coupling means.

20. The cutting apparatus for cutting an underwater structure according to claim 12, wherein said slidable coupling means include, at the first half-frame of the swinging frame, two sets of sliding rollers which engage the guiding grooves on the side of the anchoring frame.

21. The cutting apparatus for cutting an underwater structure according to claim 6, further comprising auxiliary ejecting means which assist the swinging frame in its swinging movement to drive the active portion of the penetrating/cutting frame towards the underwater structure to be cut.

22. The cutting apparatus for cutting an underwater structure according to claim 21, wherein said auxiliary ejecting means include ejecting nozzles arranged on the penetrating/cutting frame to assist the swinging frame in its swinging movement to drive the active portion of the penetrating/cutting frame towards the underwater structure to be cut, said ejecting nozzles being supplied with a pressurized fluid from supply lines.

23. The cutting apparatus for cutting an underwater structure according to claim 22, wherein the ejecting nozzles are arranged on the face of the penetrating/cutting frame which is oriented towards the anchoring frame.

24. The cutting apparatus for cutting an underwater structure according to claim 22, wherein
the penetrating/cutting frame includes:
cutting means extending between two parallel, mutually spaced tubular columns which, at one end, are transversally connected by a rigid back plate in such a manner that the penetrating/cutting frame has a force shape, and which, at a free end, carry respective perforating devices, and
the supply lines supply a pressurized fluid to one or more collecting conducts mounted along the tubular columns of the penetrating/cutting frame and operatively connected to a group of said ejecting nozzles.

25. A method for cutting an underwater structure below the level of the seabed on which it is installed using the cutting apparatus according to claim 6, comprising the following steps:
securing the anchoring frame in close proximity to the underwater structure by means of jaws at the intersection region between said structure and the seabed;
coupling the pre-assembled assembly comprising the penetrating/cutting frame and the swinging frame with the anchoring frame;
tilting the penetrating/cutting frame through an initial amount with respect to the longitudinal axis of said structure;
causing the penetrating/cutting frame to penetrate into the seabed by activating the linear actuator and, simultaneously, actuating the perforating devices and slidably driving the diamond-edged cable at a low speed in order to cause the cutting portion of the diamond-edged cable to partially wind itself around said underwater structure in a perpendicular direction thereto, the configuration of said cutting portion changing to a curved configuration;
increasing the sliding speed of the diamond-edged cable until a desired work speed is achieved and, simultaneously, actuating the compensating device to cause the cutting portion of the diamond-edged cable to take on a rectilinear configuration so as to perform a partial perpendicular cut of the structure; and
increasing the tilting amount of the penetrating/cutting frame until the cutting portion of the diamond-edged cable is driven outside of the structure in order to complete the cutting of the structure with a curved cut.
